(19) United States
(12) Patent Application Publication
(10) Pub. No.: US 2025/0005350 A1
(43) Pub. Date: Jan. 2, 2025

(54) METHOD AND SYSTEM FOR CLASSIFYING PASSENGER PROPENSITY FOR PURPOSE-BUILT VEHICLES

(71) Applicant: HL MANDO CORPORATION, Gyeonggi-do (KR)

(72) Inventor: Jeonghwan RYU, Gyeonggi-do (KR)

(21) Appl. No.: 18/385,391

(22) Filed: Oct. 31, 2023

(30) Foreign Application Priority Data
Jun. 29, 2023 (KR) 10-2023-0084341

(51) Int. Cl. G06N 3/08; G06N 3/0442; G06N 3/0455

(52) U.S. Cl. CPC G06N 3/08; G06N 3/0442; G06N 3/0455

(57) ABSTRACT

A method and system for passenger propensity classification for purpose-built vehicles perform operations including: generating time series data by collecting driving propensity data of passengers, who use the purpose-built vehicles, in a time order; outputting a plurality of new features which are an intermediate result by reducing a dimension of the time series data by training the time series data by an artificial neural network; and classifying driving propensities of passengers by applying a K-means clustering algorithm to the new features generated by reducing the dimension of the time series data.

### CROSS-REFERENCE TO RELATED APPLICATIONS

This application claims benefit and priority to Korean Patent Application No. 10-2023-0084341, filed on Jun. 29, 2023, with the Korean Intellectual Property Office, the disclosure of which is incorporated herein in its entirety by reference.

### TECHNICAL FIELD

The present disclosure generally relates to a method and a system for passenger propensity classification for purpose-built vehicles, and particularly to a method and a system for passenger propensity classification for purpose-built vehicles, which can classify propensities of various passengers using purpose-built vehicles so as to satisfy various passengers without providing or paying a separate resource or additional cost.

### BACKGROUND

In recent years, a vehicle is evolving into a purpose-built vehicle (PBV) focused on various specific purposes, not just transportation, according to the electricity of radical vehicles and the development of artificial intelligence (AI) technology.

As a result, an automotive industry is developing the purpose-built vehicle that provides customized services according to propensities of passengers.

In this trend, a mobility service, which can satisfy various passengers while consumers' consciousness is changed from the own of the vehicle to the use of the purpose-built vehicle, is being expanded.

As such, if various passengers use one purpose-built vehicle, an operation time is longer than that of the existing vehicle, which allows driving propensities of various passengers to be recorded.

As a result, it is easy to collect data and combine artificial intelligence technology that requires vast data.

Based on this, if the driving propensities of various passengers can be classified by using or applying the artificial intelligence technology, the customized services can be provided to individual passengers, thereby leading to greater satisfaction and enhancement of service quality.

Vast data is required when applying the artificial intelligence technology, but the purpose-built vehicle is used by various passengers, and therefore it makes easy to collect various and vast data.

However, if the learning and inferring by the artificial intelligence technology are made using all of the data, the consumption of resources and time will increase.

Therefore, a process of reducing a dimension of data by selecting an appropriate feature and using the artificial intelligence technology is required.

In the related art, dimension reduction technologies such as principle component analysis (PCA), linear discriminant analysis (LDA), etc., which reduce a physical dimension, are used, and the dimension reduction technology in the related art has a problem in that a characteristic difference between features can be lost in a process of reducing the physical dimension.

Artificial intelligence technology, which analyzes driver tendencies, often primarily uses a recurrent neural network (RNN) advantageous for dealing with time-series data.

In respect to input data, a feature is selected, which can specify an operation action of a passenger who operates a steering, an accelerator, a brake, etc., and a vehicle state and parameters that meet a purpose of the classification are searched and classified to prioritize an individual's propensity.

In the related art, there are many cases in which a supervised learning scheme is adopted based on the classification, and this has a problem in that a lot of resources and time are consumed because a labeling task which should match a correct answer value and the input data is required.

### SUMMARY

Some exemplary embodiment of the present disclosure may provide a method and a system for passenger propensity classification for purpose-built vehicles, which can classify propensities of various passengers using purpose-built vehicles so as to satisfy various passengers without providing paying a separate resource or additional cost.

An exemplary embodiment of the present disclosure provides a passenger propensity classification method for purpose-built vehicles which includes: generating time series data by collecting driving propensity data of passengers who use the purpose-built vehicles in a time order, outputting a plurality of new features which are an intermediate result by reducing a dimension by training the time series data by an artificial neural network, and classifying driving propensities of passengers by applying a K-means clustering algorithm to the new feature of the reduced dimension.

When the driving propensity data is vehicle operation data, the driving propensity data may include data related to a yaw rate, a steering angle, a vehicle speed, a longitudinal acceleration, and a transverse acceleration.

The time series data may learn a long short-term memory (LSTM) based autoencoder.

A plurality of representative passenger propensity clusters may be generated by applying the K-means clustering algorithm to the new feature of the reduced dimension.

When passenger propensities are classified for new data after generating the representative passenger propensity cluster, center coordinates of the plurality of representative passenger propensity clusters may be used.

After the dimension for the new data is reduced, center coordinates of a cluster closest to new features of the reduced dimension are obtained to classify the cluster into the propensity of the new data.

Alternatively, another exemplary embodiment of the present disclosure provides a passenger propensity classification method for purpose-built vehicles, which may include: a dimension reduction model generating step of generating time series data by collecting driving propensity data of passengers who use the purpose-built vehicles in a time order, and reducing a dimension by training the time series data by an artificial neural network; a representative passenger propensity cluster generating step of outputting a plurality of new features which is an intermediate result of the reduced dimension, and applying a K-mean clustering algorithm to the new feature to generate a plurality of representative passenger propensity clusters; and a passenger propensity classifying step of calculating a distance between a new feature derived by dimension-reducing driving propensity data of new passengers and a center of the plurality of representative passenger propensity clusters, and selecting a representative passenger propensity cluster having a center closest to the new feature.

The generation of the time series data may be made by collecting driving propensity data of a plurality of passengers, selecting the driving propensity data as a plurality of features to suit the purpose, and arranging the plurality of selected features of the plurality of passengers in the time order.

When the passenger driving propensity classification is the purpose, the driving propensity data may be selected as features for a yaw rate, a steering angle, a vehicle speed, a longitudinal acceleration, and a transverse acceleration.

The time series data may learn an autoencoder, and the autoencoder may be a long short-term memory (LSTM) based autoencoder.

Only an encoder may be separated in the learned autoencoder structure and used as a dimension reduction model.

When the time series data is input into the encoder, the plurality of new features which is the intermediate result of the reduced dimension may be output.

In the representative passenger propensity cluster generating step, when the K-mean clustering algorithm is applied to the new feature, a plurality of clusters and center coordinate pairs of respective clusters may be obtained.

A result generated by the plurality of clusters is evaluated through a silhouette coefficient to derive the number of optimized clusters.

Meanwhile, yet another exemplary embodiment of the present disclosure provides a passenger propensity classification system for purpose-built vehicles, which may include: a time series data generation unit generating time series data by collecting driving propensity data of passengers who use the purpose-built vehicles in a time order; a dimension reduction model generation unit reducing a dimension by training the time series data by an artificial neural network; a representative passenger propensity cluster generation unit outputting a plurality of new features which is an intermediate result of the reduced dimension, and applying a K-mean clustering algorithm to the new feature to generate a plurality of representative passenger propensity clusters; and a passenger propensity classification unit calculating a distance between a new feature derived by dimension-reducing driving propensity data of new passengers and a center of the plurality of representative passenger propensity clusters, and selecting a representative passenger propensity cluster having a center closest to the new feature.

The time series data may learn a long short-term memory (LSTM) based autoencoder.

Only an encoder is separated in the learned autoencoder structure and used as a dimension reduction model, and when the time series data is input into the encoder, the plurality of new features which is the intermediate result of the reduced dimension may be output.

When the K-mean clustering algorithm is applied to the new feature, the representative passenger propensity cluster generation unit may obtain a plurality of clusters and center coordinate pairs of respective clusters.

A result generated by the plurality of clusters is evaluated through a silhouette coefficient to derive the number of optimized clusters.

Specific details of exemplary embodiments and alternatives are included in the Detailed Description and the Drawings.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the invention, and the present disclosure will be defined only by the scope of each claim of the claims.

According to the solving means of the problem, some of embodiments of the present disclosure has the following effects.

According to some embodiments of the present disclosure, a dimension may be reduced based on an autoencoder to prevent a characteristic difference between features from being lost and generate a new characteristic difference between the features.

According to certain embodiment of the present disclosure, propensities of various passengers who use purpose-built vehicles may be classified by generating a plurality of representative passenger propensity clusters by applying a K-mean clustering algorithm to a new feature of a reduced dimension, thereby satisfying various passengers without providing paying a separate resource or additional cost.

The foregoing Summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flowchart illustrating a method for classifying passenger propensity for purpose-built vehicles in order according to the present disclosure.

FIG. 2 is a block diagram for illustrating a system for classifying passenger propensity according to an embodiment of the present disclosure.

FIG. 3 is a diagram for describing a time series data generation step in a method for classifying passenger propensity for purpose-built vehicles according to an embodiment of the present disclosure.

FIG. 4 is a diagram for describing a dimension reduction model generation step in a method for classifying passenger propensity for purpose-built vehicles according to an embodiment of the present disclosure.

FIG. 5 is a graph for describing a representative passenger propensity cluster generation step in a method for classifying passenger propensity for purpose-built vehicles according to an embodiment of the present disclosure.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

Hereinafter, exemplary embodiments of a method and a system for passenger propensity classification for purpose-built vehicles according to the present disclosure will be described in detail with reference to the accompanying drawings. For reference, terms or words used in the present specification and claims should not be interpreted as being limited to typical or dictionary meanings, but should be interpreted as having meanings and concepts which comply with the technical spirit of the present disclosure, based on the principle that an inventor can appropriately define the concept of the term to describe his/her own invention in the best manner. Further, configurations illustrated in the exemplary embodiments and drawings disclosed in the present specification are only the most preferred embodiment of the present disclosure and do not represent all of the technical spirit of the present disclosure, and thus it is to be understood that various equivalents and modified examples, which may replace the configurations, are possible when filing the present application.

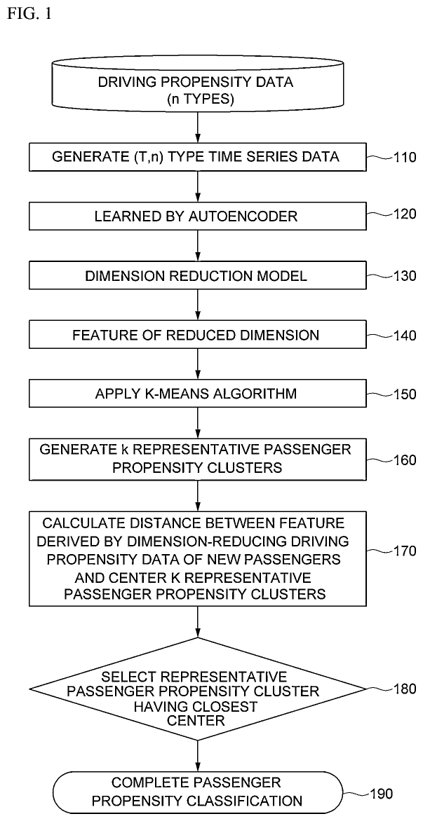

FIG. 1 is a flowchart illustrating a method for classifying passenger propensity for purpose-built vehicles in order according to the present disclosure.

The method for classifying passenger propensity for the purpose-built vehicles according to an embodiment of the present disclosure generates time series data by collecting driving propensity data of passengers who use purpose-built vehicles in time order (step 110), outputs a plurality of new features which are an intermediate result by reducing a dimension of the time series data by training the time series data by an artificial neural network (step 130), and classifies driving propensities of the passengers by applying a K-means clustering algorithm to the new feature of the reduced dimension of the time series data (step 150). Further, an autoencoder may learn the time series data (step 120). Step 120 will be described in detail with reference to FIG. 4.

For example, the driving propensity data may be vehicle operation data which is data related to operations of a vehicle. The driving propensity data may include, for instance, but not limited to, data related to a yaw rate, a steering angle, a speed, a longitudinal acceleration, and a transverse acceleration of a vehicle.

The K-means clustering algorithm is an algorism for vector quantization, originally from signal processing, that aims to partition observations into clusters in which each observation belongs to the cluster with the nearest mean (cluster centers or cluster centroid), serving as a prototype of the cluster. The K-means clustering algorithm as an algorithm that binds given data into k clusters operates in a scheme of minimizing a distribution of each cluster and a distance difference.

The K-means clustering algorithm which is a kind of autonomous learning serves to attach a label to input data with no label.

The K-means clustering algorithm is applied to reduce resources and time as compared with the related art in which a labeling task which matches a correct answer value and the input data is required.

Alternatively, the passenger propensity classification method for the purpose-built vehicles according to an embodiment of the present disclosure may be configured to include a time series data generation step (110), a dimension reduction model generation step (130), a representative passenger propensity cluster generation step (160), and a passenger propensity classification step (170).

The time series data generation step (110) is performed for generating the time series data by collecting the driving propensity data of passengers, who use the purpose-built vehicles, in time order. The time series data is a sequence of data points indexed in time order.

The dimension reduction model generation step (130) is performed for reducing a dimension by training the time series data generated in the time series data generation step (110) by the artificial neural network.

The representative passenger propensity cluster generation step (160) is performed for outputting a plurality of new features which are an intermediate result of the dimension reduced in the dimension reduction model generation step (130), and applying the K-mean clustering algorithm to the new features (step 150) to generate a plurality of representative passenger propensity clusters (step 160).

The passenger propensity classification step (170) is performed for calculating a distance between a new feature derived by dimension-reducing driving propensity data of new passengers and a center of the plurality of representative passenger propensity clusters after generating the cluster in the representative passenger propensity cluster generation step (160), and selecting a representative passenger propensity cluster having a center closest to the new feature (step 180).

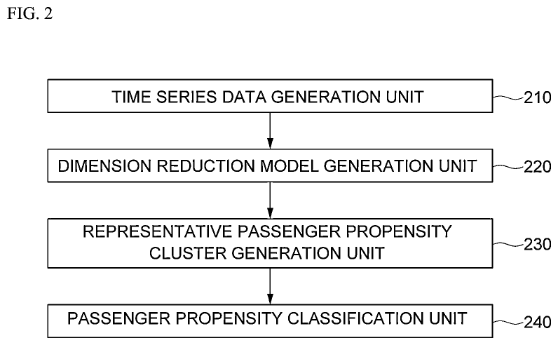

FIG. 2 is a block diagram for illustrating a system for classifying passenger propensity according to an embodiment of the present disclosure. A system for passenger propensity classification for purpose-built vehicles according to an embodiment of the present disclosure may include a time series data generation unit 210, a dimension reduction model generation unit 220, a representative passenger propensity cluster generation unit 230, and a passenger propensity classification unit 240. The time series data generation unit 210, the dimension reduction model generation unit 220, the representative passenger propensity cluster generation unit 230, the passenger propensity classification unit 240, and any element included in the system for passenger propensity classification for purpose-built vehicles may be implemented by one or more memories configured to store computer executable instructions and/or one or more processors configured to execute the computer executable instructions stored in the memory.

The time series data generation unit 210 may be configured to generate time series data by collecting driving propensity data of passengers, who use the purpose-built vehicles, in time order.

The dimension reduction model generation unit 220 may be configured to reduce a dimension by training the time series data generated by the time series data generation unit 210 by the artificial neural network.

The representative passenger propensity cluster generation unit 230 may be configured to output a plurality of new features which are an intermediate result of the dimension reduced in the dimension reduction model generation unit 220, and apply the K-mean clustering algorithm to the new features to generate a plurality of representative passenger propensity clusters.

The passenger propensity classification unit 240 may be configured to calculate a distance between a new feature derived by dimension-reducing driving propensity data of new passengers and a center of the plurality of representative passenger propensity clusters after generating the cluster by the representative passenger propensity cluster generation unit 230, and select a representative passenger propensity cluster having a center closest to the new feature to complete passenger propensity classification.

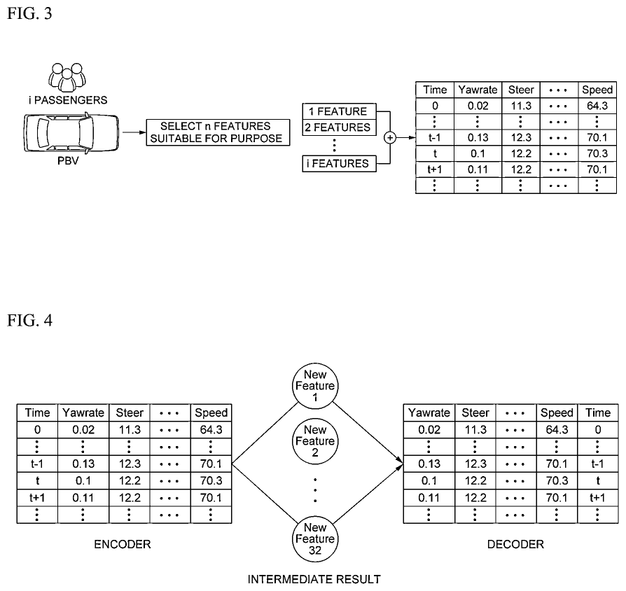

FIG. 3 is a diagram for describing a time series data generation step in a method for classifying passenger propensity for purpose-built vehicles according to an embodiment of the present disclosure.

The generation of the time series data is performed by collecting driving propensity data of a plurality of passengers, selecting a plurality of features from the driving propensity data to suit the purpose, and arranging the plurality of selected features of the plurality of passengers in time order.

For example, when the purpose for the selecting the driving propensity data is passenger driving propensity classification, features for the yaw rate, the steering angle, the vehicle speed, the longitudinal acceleration, and the transverse acceleration may be selected from the driving propensity data.

Specifically, with reference to FIG. 3, data of I passengers are collected, n features are selected according to the purpose, and then n selected features of all i passengers are accumulated in time order to generate the time series data.

FIG. 4 is a diagram for describing a dimension reduction model generation step in a method for classifying passenger propensity for purpose-built vehicles according to an embodiment of the present disclosure.

A long short-term memory (LSTM) based autoencoder may learn time series data.

The autoencoder is a neural network model that learns a compressed expression of an input.

Technologically, the neural network model is trained by using a supervised learning method called self-supervised learning, but the autoencoder may be an unsupervised learning method.

In general, the autoencoder is trained as a part of a wide range of model attempting input reproduction.

A design of the autoencoder model limits an architecture to cause a bottleneck phenomenon at a middle point of a reconstructed model of input data to intentionally cause such a problem.

The type and usage of the autoencoder are diversified, but generally a feature extraction model is used as the autoencoder.

In this case, once the model is actuated, a reconstruction aspect of the model may be discarded and a model up to a bottleneck point may be used.

An output in the bottleneck phenomenon is a vector having a fixed length which provides the compressed expression of the input data.

Then, input data of a domain may be provided to the model, and the output in the bottleneck phenomenon may be used for a feature vector or a dimension reduction of the supervised learning model for visualization.

An LSTM autoencoder is an autoencoder implemented for sequence data by using an encoder-decoder LSTM architecture.

In a given sequence dataset, the encoder-decoder LSTM is configured to read, encode, decode, and regenerate an input sequence.

A performance of the model is evaluated based on an input sequence reproduction ability.

When the model reaches a desired performance level, a decoder part of the model is removed and only the encoder model remains.

The model may be used to encode the input sequence to a fixed-length vector.

As a result, the vector as an input of another supervised learning model may be used in various applications in addition to the compressed expression of the sequence.

In a learned autoencoder structure, when only the encoder is separated and used as the dimension reduction model, a well-learned autoencoder predicts original data with the intermediate result which is the reduced dimension, and as this is more accurate, the intermediate result of the reduced dimension better implies characteristics of the original data.

As illustrated in FIG. 4, when the time series data is input into the encoder, new features 1 to 32 which are the intermediate result of the reduced dimension of the time series data are output.

As a result, the dimension of time series data having a size of time (t)*the number of features (n) is reduced to 32.

The autoencoder inputs the intermediate result of the reduced dimension of the time series data as an original input of a decoder

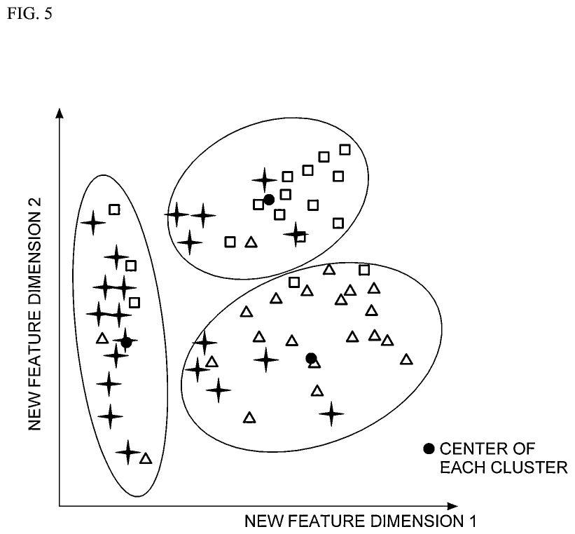

FIG. 5 is a graph for describing a representative passenger propensity cluster generation step in a method for classifying passenger propensity for purpose-built vehicles according to an embodiment of the present disclosure.

In the step of generating a representative passenger propensity cluster, when the K-mean clustering algorithm is applied to the new features, a plurality of clusters and center coordinate pairs of respective clusters may be obtained.

That is, when the number of clusters is determined to be C (e.g., 2 to 9) and the K-mean clustering algorithm is applied to the new features, C clusters and C center coordinate pairs of the clusters may be obtained.

A best number of clusters may be derived by evaluating a result of dividing by 2 to 9 clusters through a silhouette coefficient.

A value of the silhouette coefficient may be obtained through calculation of distances between each data point and surrounding data points, and whether data in the cluster are well collected and whether the clusters are well distinguished from each other are used as a measure for evaluating clustering.

For example, as illustrated in FIG. 5, when three clusters are set to be formed, if a best silhouette coefficient is provided, three clusters and three pairs of center coordinates of the clusters may be set as a representative passenger propensity cluster.

The silhouette coefficient obtains a better score as being closer to a cluster to which an element in one cluster belongs and farther from another cluster.

That is, as the clusters are well classified according to characteristics, the score is higher.

When a propensity for new data is classified after the representative cluster is formed, a center coordinate of the representative clusters is used.

After the dimension for the new data is reduced, center coordinates of a cluster closest to new features of the reduced dimension are obtained to classify the cluster into the propensity of the new data.

As such, some embodiments of the present disclosure may have an advantage in that the dimension is reduced using the autoencoder to prevent a characteristic difference between the features from being lost and generate a new characteristic difference between the features, and propensities of various passengers who use purpose-built vehicles are classified by generating a plurality of representative passenger propensity clusters by applying the K-mean clustering algorithm to the new feature of the reduced dimension, thereby satisfying various passengers without providing or paying a separate resource or additional cost.

The aforementioned present invention is not limited to the aforementioned embodiments and the accompanying drawings, and it will be obvious to those skilled in the technical field to which the present disclosure pertains that various substitutions, modifications, and changes may be made within the scope without departing from the technical spirit of the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method for passenger propensity classification for purpose-built vehicles, the method comprising:
generating time series data by collecting driving propensity data of passengers, who use the purpose-built vehicles, in time order;
outputting a plurality of new features generated by reducing a dimension of the time series data by training the time series data by an artificial neural network; and
classifying driving propensities of the passengers by applying a clustering algorithm to the new features generated by reducing the dimension of the time series data.

2. The method of claim 1, wherein the driving propensity data includes data related to one or more of a yaw rate, a steering angle, a vehicle speed, a longitudinal acceleration, and a transverse acceleration of the purpose-built vehicles.

3. The method of claim 1, wherein a long short-term memory (LSTM) based autoencoder is configured to learn the time series data.

4. The method of claim 1, further comprising generating a plurality of representative passenger propensity clusters by applying the clustering algorithm to the new features generated by reducing the dimension of the time series data, wherein the clustering algorithm includes a K-means clustering algorithm.

5. The method of claim 4, further comprising, when classifying driving propensities for new data after the generating of the plurality of representative passenger propensity clusters, using center coordinates of the plurality of representative passenger propensity clusters.

6. The method of claim 5, further comprising, after reducing a dimension for the new data, obtaining center coordinates of a cluster closest to new features of the reduced dimension for the new data to classify the cluster, closest to new features of the reduced dimension for the new data, into one or more of the driving propensities for the new data.

7. A method for passenger propensity classification for purpose-built vehicles, the method comprising:
generating time series data by collecting driving propensity data of passengers, who use the purpose-built vehicles, in time order, and reducing a dimension of the time series data by training the time series data by an artificial neural network;
outputting a plurality of new features which are an intermediate result of reducing the dimension of the time series data, and applying a clustering algorithm to the new features to generate a plurality of representative passenger propensity clusters; and
calculating a distance between a new feature, derived by reducing a dimension of time series data generated from driving propensity data of one or more new passengers, and a center of the plurality of representative passenger propensity clusters, and selecting a representative passenger propensity cluster having a center closest to the new feature among the plurality of representative passenger propensity clusters.

8. The method of claim 7, wherein the generating of the time series data comprises collecting the driving propensity data of the plurality of passengers, selecting a plurality of features from the driving propensity data, and arranging the selected features of the plurality of passengers in time order.

9. The method of claim 8, wherein features for a yaw rate, a steering angle, a vehicle speed, a longitudinal acceleration, and a transverse acceleration are selected from the driving propensity data.

10. The method of claim 7, further comprising learning the time series data by an autoencoder.

11. The method of claim 10, wherein the autoencoder comprises a long short-term memory (LSTM) based autoencoder.

12. The method of claim 10, further comprising, after the learning of the time series data by the autoencoder, removing a decoder from the autoencoder and remaining an encoder in the autoencoder to be used as a dimension reduction model.

13. The method of claim 12, wherein when the time series data is input into the encoder, the plurality of new features which are the intermediate result of reducing the dimension of the time series data is output.

14. The method of claim 7, wherein the applying of the clustering algorithm to the new features comprises generating the plurality of representative passenger propensity clusters and center coordinates of each of the plurality of representative passenger propensity clusters.

15. The method of claim 14, further comprising evaluating a result generated by the plurality of representative passenger propensity clusters through a silhouette coefficient to optimize a number of the representative passenger propensity clusters.

16. A system for passenger propensity classification for purpose-built vehicles, the system comprising:
a memory; and
a processor that, when executing computer executable instructions stored in the memory, is configured to:
generate time series data by collecting driving propensity data of passengers, who use the purpose-built vehicles, in time order;
reduce a dimension of the time series data by training the time series data by an artificial neural network;
output a plurality of new features which are an intermediate result of reducing the dimension of the time series data, and apply a clustering algorithm to the new features to generate a plurality of representative passenger propensity clusters; and
calculate a distance between a new feature, derived by reducing a dimension of time series data generated from driving propensity data of one or more new passengers, and a center of the plurality of representative passenger propensity clusters, and selecting a representative passenger propensity cluster having a center closest to the new feature among the plurality of representative passenger propensity clusters.

17. The system of claim 16, wherein the memory is configured to store a long short-term memory (LSTM) based autoencoder for learning the time series data.

18. The system of claim 17, wherein:
the memory is configured to store an encoder having a dimension reduction model, and
the processor is configured to, when the time series data is input into the encoder, output the plurality of new features which are the intermediate result of reducing the dimension of the time series data.

19. The system of claim 16, wherein the processor is configured to, when applying the clustering algorithm to the new features, generate the plurality of representative passenger propensity clusters and center coordinates of each of the plurality of representative passenger propensity clusters.

20. The system of claim 19, wherein the processor is configured to evaluate a result generated by the plurality of representative passenger propensity clusters through a silhouette coefficient to optimize a number of the representative passenger propensity optimized clusters.
